(19) United States
(12) Patent Application Publication
(10) Pub. No.: US 2007/0252344 A1
(43) Pub. Date: Nov. 1, 2007

(54) Intermediary Bushing for a Chuck and Method for Producing the Same

(76) Inventor: Thomas Retzbach, Bonningheim (DE)

Correspondence Address: Joseph & Berenato, III;Berenato, White & Stavish, 6550 Rock Spring Drive, Suite 240, Bethesda, MD, 20817, US

(21) Appl. No.: 10/578,553

(22) PCT Filed: Nov. 5, 2004
(86) PCT No.: PCT/EP04/12549

§ 371 Date: Mar. 6, 2007

(30) Foreign Application Priority Data
Nov. 6, 2003 (EP) 03025505.3

(51) Int. Cl. B23B 5/22

(52) U.S. Cl. 279/55

(57) ABSTRACT

The invention relates to an intermediary bushing to be inserted into the central receptacle of a chuck with a cylindrical body which has a central clamp hole in the form of a through hole, the body having several radial slots distributed along its outer circumference which extend over the whole axial length of the intermediary bushing, which is characterised in that the slots have a maximum width of 0.6 mm, and the outer contour, the slots and the clamp hole of the intermediary bushing are spark-eroded, and that over its whole length the body has a through slot extending from its outer circumference to the inner circumference with a maximum width of 0.6 mm. The invention further relates to a method for producing this type of intermediary bushing.

This invention relates to an intermediary bushing to be inserted into the central receptacle of a chuck according to the preamble to Claim 1. Furthermore, the invention relates to a chuck with a chuck body in which a central receptacle is formed for the shaft of a tool to be clamped, and a coolant supply duct which extends between the end of the chuck body on the machine side and the receptacle in order to supply a coolant to the end on the machine side of a tool pushed into the receptacle, an intermediary bushing being inserted into the receptacle. Finally, the invention relates to a method for producing an intermediary bushing.

Chucks of the aforementioned type are known in different embodiments, and are used in practice in order to fix in place the shaft of a tool such as for example the shaft of a drill or a cutter, in the working spindle of a corresponding machine tool. With the known chucks which are designed, for example, as expanding chucks or as heat shrinkage chucks, the clamp span is very limited so that the diameters of the receptacle, on the one hand, and of the tool to be clamped on the other hand, must correspond to one another.

In order also to clamp tools with a chuck which have a substantially smaller diameter than the chuck receptacle, so-called intermediary bushings are often used in practice which are pushed into the chuck receptacle so as to reduce the clamp diameter (see WO 02 051 571 A1). These intermediary bushings have a cylindrical body with a central clamp hole which has several radial slots distributed along its outer circumference which extend over the whole length of the intermediary bushing. These slots serve to give the intermediary bushing the elasticity required for transferring the clamping forces.

The known intermediary bushings are generally produced by machining processing methods. The bushing bodies are generally first of all turned and then smoothed, and the slots are also applied to the bushing body by machining by means of sawing or grinding. This type of production is expensive and is also associated with long cycle times due to the large number of different production processes. This is particularly the case when the clamp holes are very small, for example having a diameter of less than 6 mm, or the requirements for concentric accuracy are very stringent, the concentric tolerances needing to be, for example, less than 0.005 mm.

A further problem can occur if the intermediary bushings for clamping tools are used with an internal coolant supply because in this case, expensive sealing measures have to be taken in order to prevent coolant and/or lubricant supplied via the chuck body from passing into the radial slots and from flowing past the tool through the slots and out of the chuck body as leakage.

The objective, therefore, of this invention is to provide an intermediary bushing of the type specified at the start, which is simple to produce, which makes possible a high level of production accuracy, in particular with regard to the concentric tolerances which can be achieved, and in addition reduces the risk of coolant fluid leaks. Furthermore, a chuck with this type of intermediary bushing and a method for producing the same are to be provided.

According to this invention, this objective is fulfilled with an intermediary bushing of the type specified at the start by means of the characterising features of Claim 1.

According to the invention, the outer contours with the slots and the central clamp hole of the intermediary bushing are produced by an electrical discharge machining process with a single machine clamping. As a result of this production process it is possible to produce the intermediary bushings according to the invention automatically. Because production takes place in one machine clamping, very high levels of production accuracy are also made possible. Here, the through slot is associated with the advantage that the intermediary bushing is open on one side so that during operation only small clamping force losses occur. During this electrical discharge machining process, the through slot can be produced between the processing of the outer and the inner contour so that production of a preliminary hole can be dispensed with. Very thin-walled wall thickness of <1.0 mm can also be produced with a high level of accuracy and low processing costs.

Furthermore, it is an essential part of the invention that in the case where tools are to be clamped with an internal coolant supply, expensive sealing measures are at least largely dispensed with because with the intermediary bushings and according to both aspects of the invention, the spark-eroded slots are of such a small width that the flow resistance in the slots is so great that leakage of the coolant and/or lubricant through the slots is largely excluded. If, nevertheless, for reasons relating to safety, additional sealing media such as for example plastic masses are used, the small width of the slots prevents the sealing masses from extruding out of the slots.

The same also applies of course when using solid materials, such as e.g. O-ring cords which can also withstand coolant pressures of well over 100 bar. Finally, the invention offers the advantage that it is difficult for dirt to collect in the narrow slots. It has proven to be sufficient for the slot width to be =0.6 mm. With preferred masses, however, the (through) slots should have a maximum width of 0.35 mm, and in particular a maximum width of 0.3 mm.

With regard to further advantageous embodiments of the invention, reference is made to the sub-claims and to the following description of an example of an embodiment with reference to the attached drawings. The drawings show as follows:

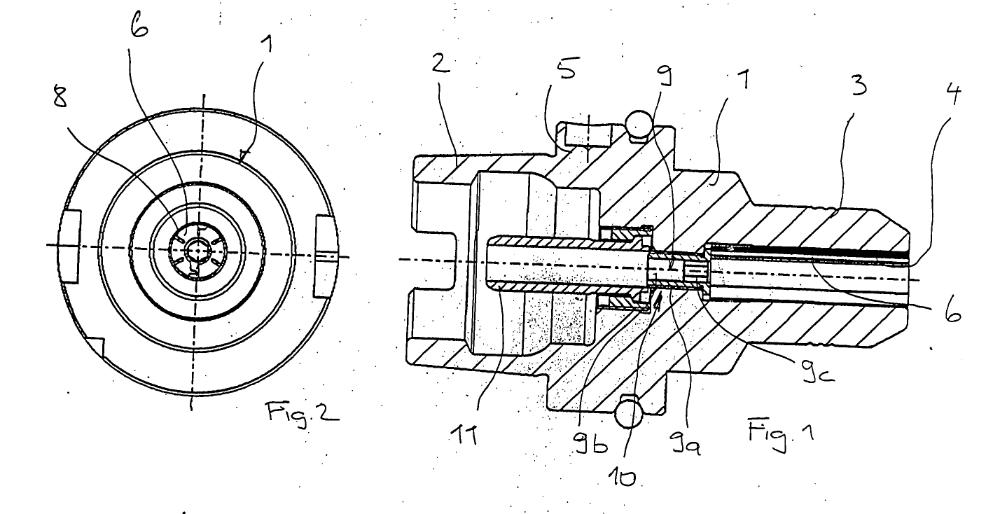

FIG. 1 a longitudinal section of a first embodiment of a chuck in the form of a heat shrinkage chuck according to this invention,

FIG. 2 a front view of the chuck from FIG. 1,

FIG. 3 an intermediary bushing of the chuck from FIG. 1 shown in perspective and enlarged,

FIG. 4 a front view of the clamping bushing from FIG. 3,

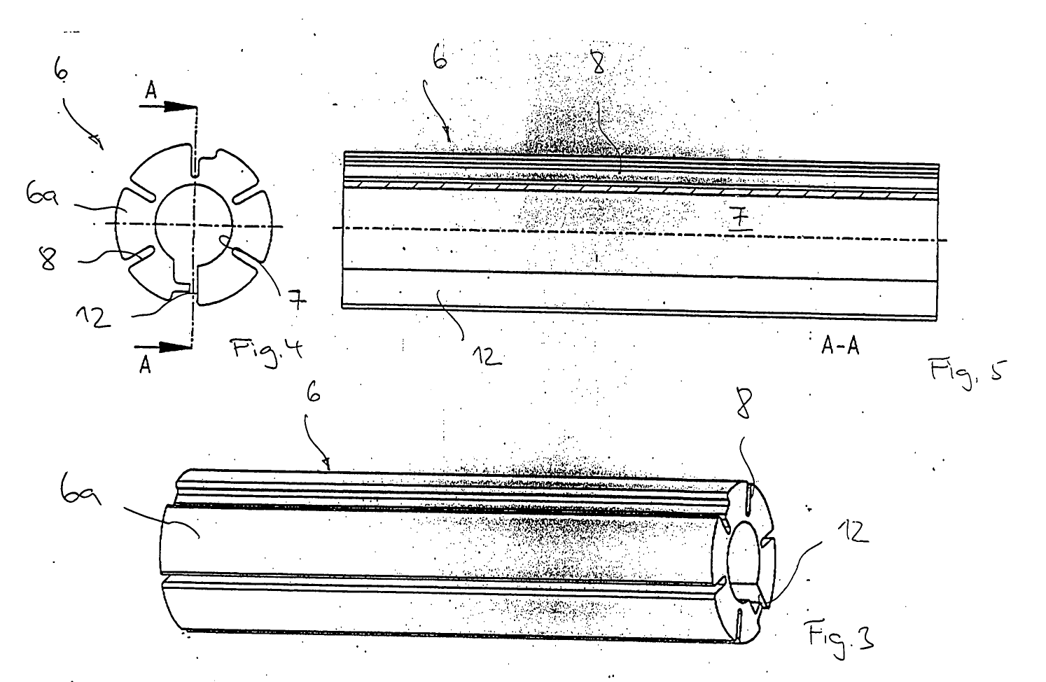

FIG. 5 a longitudinal section of the intermediary bushing along line A-A in FIG. 4,

FIG. 6 a further intermediary bushing for a chuck according to FIG. 1, shown in perspective and enlarged,

FIG. 7 a front view of the clamping bushing from FIG. 6, and

FIG. 8 the intermediary bushing in the sunken section along line AB-A in FIG. 7.

In FIGS. 1 and 2 an embodiment of a chuck according to this invention is shown in a longitudinal section and in a front view. This chuck has a chuck body 1 made of a rigid material which at its one end region has, in a known manner, an attachment cone 2 for clamping onto a rotationally driven working spindle of a machine tool. On the other end of the chuck body 1 an attachment shaft 3 with a central receptacle 4 is provided into which a cylindrical shaft of a tool, such as for example a drill or a cutter, can be pushed, and between the attachment cone 2 and the attachment shaft 3 there lies a central portion 5 of increased diameter.

The chuck shown is in the form of a heat shrinkage chuck. Alternatively, however, an embodiment in the form of an expanding chuck is possible, the chuck then having, in a known manner, an expanding clamping mechanism in the region of the attachment shaft 3.

In order also to be able to use the chuck 1 for clamping shafts of tools with a diameter which is substantially smaller than the diameter of the receptacle 4, an intermediary bushing 6 is inserted into the receptacle 4. This intermediary bushing 6 has a cylindrical body 6a, the outer diameter of which corresponds to the diameter of the receptacle 4, and which has a clamp hole 7 in the form of a through hole with a diameter which approximately corresponds to the diameter of the tools to be clamped and which can be less than 6 mm. As can be seen particularly well in FIGS. 3 to 5, the intermediary bushing 6 has radial slots 8 distributed along its outer circumference which extend over the whole length of the intermediary bushing 6 and extend from the outer circumference of the intermediary bushing 6 towards the clamp hole 7, only very narrow strips of material remaining between the slots 8 and the clamp hole 7.

For the axial positioning of the intermediary bushing 6 or of a tool pushed into this intermediary bushing 6, in the receptacle 4 an axial stop element is provided which is held in the chuck body 1 such as to be axially adjustable. More precisely, the axial stop element in the embodiment shown is in the form of a pre-adjustable screw 9 which is screwed into an axial through hole 10 of the chuck body 1 adjacent to the receptacle 4, for which purpose it is provided, in its shaft region, with an outer thread section 9a. Furthermore, the pre-adjustable screw 9 has a through hole 9b. This is formed on its end region on the receptacle side in the form of a hexagon socket so that the pre-adjustable screw 9 turns by means of an Allen key and, in this way, can be adjusted axially.

The tools to be clamped are generally tools with an inner coolant supply and which have a central through hole which extends from the end on the receptacle side to the cutting edge of the tool so as to supply a coolant and/or lubricant to the tool's cutting edge. This coolant and/or lubricant, which can be for example an air/oil mixture in the form of an oil mist, is supplied to the end of the tool on the machine side via a coolant duct formed in the chuck body 1 which is substantially formed by a coolant supply pipe 11, which extends between a transfer element of the working spindle and the pre-adjustment screw 9, and the through hole 9b of the pre-adjustable screw 9.

In order to prevent the coolant and/or lubricant supplied from being able to flow past a tool inserted into the clamp hole 7 of the intermediary bushing 6 via the radial slots 8 of the intermediary bushing 6 and to exit from the chuck as leakage, the width of the slots 8 is of dimensions sufficiently small such that coolant and/or lubricant is at least substantially prevented from passing into the slots 8 because the flow resistance in the slots 8 is too great for the coolant. Further sealing media in the slots can therefore be partially totally dispensed with. If sealing media such as e.g. plastic masses are used, the small width of the slots 8 therefore prevents these sealing masses from extruding out. The same applies of course when using solid materials such as e.g. O-ring cords which can also withstand coolant pressures of well over 100 bar.

The slots 8, which have a maximum width of 0.6 mm, and in particular a maximum width of 0.35 mm, are produced using a wire-cut electrical discharge machining process. More precisely, according to this invention provision is made such that the whole intermediary bushing 6 is produced from a blank using an electrical discharge machining process. As shown schematically in particular in FIG. 6, the outer contour of the intermediary bushing 6 with the slots 8 is produced first of all, and then the electrical discharge machining wire is moved radially inwards in the wall of the intermediary bushing 6, thus forming a radial through slot 12 so as to produce the inner contour. This production of the intermediary bushing 6 by means of an electrical discharge machining process in one machine clamping makes it possible to achieve very high levels of production accuracy, by means of which in particular problems relating to concentricity can be avoided. Because the intermediary bushing 6 has slots made through it, the use of an initial hole is also superfluous. This is particularly important with clamp diameters of less than 0.5 mm because the production costs are thus further reduced.

1. An intermediary bushing to be inserted into the central receptacle (4) of a chuck with a cylindrical body (6a) which has a central clamp hole (7) in the form of a through hole, the body (6a) having several radial slots (8) distributed along its outer circumference which extend over the whole axial length of the intermediary bushing (6), characterised in that the slots (8) have a maximum width of 0.6 mm, and the outer contour, the slots (8) and the clamp hole (7) of the intermediary bushing (6) are spark-eroded, and that over its whole length the body (6a) has a through slot (12) extending from its outer circumference to the inner circumference with a maximum width of 0.6 mm.

2. The intermediary bushing according to claim 1, characterised in that the slots (8) have a maximum width of 0.35 mm, and in particular a maximum width of 0.5 mm.

3. The intermediary bushing according to claim 1, characterised in that the through slot (12) has a maximum width of 0.35 mm, and in particular a maximum width of 0.3 mm.

4. A chuck with a chuck body (1) in which a central receptacle (4) is formed for the shaft of a tool to be clamped, and a coolant supply duct which extends between the end of the chuck body (1) on the machine side and the receptacle (4), so as to supply the end of a tool pushed into the receptacle (4) on the machine side with a coolant, an intermediary bushing (6) being inserted into the receptacle (4), characterised in that the intermediary bushing (6) is formed according to claim 1.

5. The chuck according to claim 4, characterised in that a sealing material is inserted into the slots (8).

6. A method for producing an intermediary bushing (6) to be inserted into the receptacle (4) of a chuck with a cylindrical body (6a) which has a central clamp hole (7) in the form of a through hole, several radial slits being provided, distributed along the outer circumference of the cylindrical body (6a) and which extend over the whole axial length of the intermediary bushing (6), characterised in that over its whole length the body (6a) has a through slit (12) extending from its outer circumference to the inner circumference, the outer contour, the central lamp hole (7) and the slots (8) and/or the through slot (12) being produced with a maximum width of 0.6 mm by means of an electrical discharge machining process n a single machine clamping.

7. The method according to claim 6, characterised in that the slots (8) are produced with a maximum width of 0.3 mm.
